(19) United States
(12) Patent Application Publication
(10) Pub. No.: US 2005/0108866 A1
(43) Pub. Date: May 26, 2005

(54) Manufacturing method for color ball

(76) Inventor: Chao-Kuo Huang, Lu-Chou City (TW)

Correspondence Address: RABIN & Berdo, PC, 1101 14TH STREET, NW, SUITE 500, WASHINGTON, DC, 20005, US

(21) Appl. No.: 10/721,237

(22) Filed: Nov. 26, 2003

(51) Int. Cl. B23P 11/00; B21D 39/03

(52) U.S. Cl. 29/433; 29/428

(57) ABSTRACT

The present invention provides a manufacturing method for color balls. A piece of glittery foil is cut into shredded slips while the other piece of glittery foil is cut into the slips with different geometric shapes on one end. Then the shredded slips and the slips with different geometric shapes on one end are tied by two threads so as to form a downy fluffy garland. After that, the fluffy garland is coiled around a hemispheric base and is attached with fixing pins, forming a color ball. This method is to increase the manufacturing speed as well as reduce the manufacturing cost.

### BACKGROUND OF THE INVENTION

1. Field of the Invention

The present invention provides a manufacturing method for color balls, especially to a method that can increase the producing speed and reduce the manufacturing cost. The three-dimensional color ball is formed by a fluffy garland wound around on a hemispheric base with fixing pins.

2. Description of the Prior Art

Generally, garlands for decoration are made of paper or plastic with single color. Users need to design the shape and then glue the garlands inside the house, or coil them directly on the presents or Christmas tree. For achieving better effect, the garland is made into color balls and then glue on the presents by the two-faced tape. However, such kind of color balls can't be applied on Christmas trees.

Moreover, it's time-consuming to make a color balls from garlands manually. Thus the manufacturing cost is high and such products can't be mass-produced. Furthermore, the quality of hand-knit balls is difficult to control.

In addition, there is another way to produce color balls. Cutting the glittery foils into slips while one end of the slips still connects on the glittery foil, then doubling the glittery foil, folding it into a ball. This is still a manual operation, have the same problems mentioned above.

### SUMMARY OF THE INVENTION

Therefore it is a primary object of the present invention to provide a manufacturing method for color balls. The three-dimensional color ball is made by a fluffy garland wound on the surface of a hemisphere and then is fixed by fixing pins thereon. In accordance with the method mentioned above, the manufacturing speed can be increased while the cost is down, Thus the market competitiveness is strengthened.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a schematic drawing showing slips cutting from a glittery foil;

FIG. 2 is a schematic drawing showing the glittery foil being cut into slips with different geometric shapes.

FIG. 3 is a schematic drawing showing the slips being twisted into fluffy garlands by threads;

FIG. 4 is a schematic drawing showing the slips being twisted into fluffy garlands by threads;

FIG. 5 is an elevational view of a hemispheric base in accordance with the present invention;

FIG. 6 is a schematic drawing of a color ball in accordance with the present invention.

### DETAILED DESCRIPTION OF THE PREFERRED EMBODIMENT

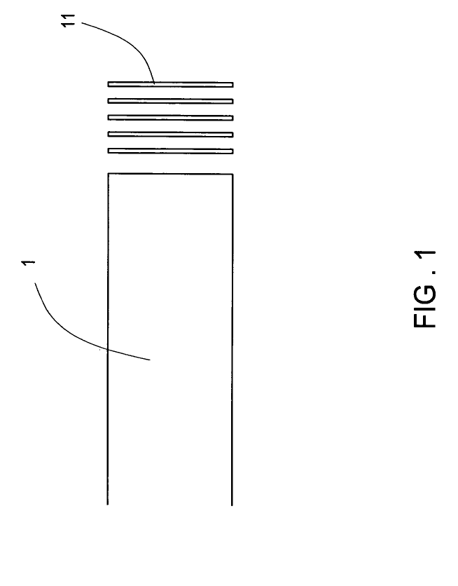

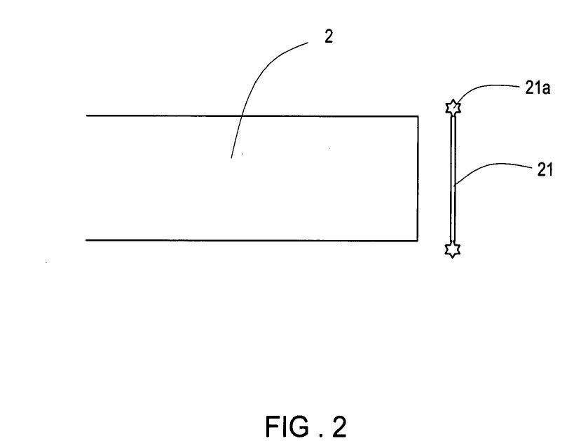

Refer to FIG. 1 & FIG. 2, the present invention is composed of following steps,

(a) cutting a piece of glittery foil 1 into a plurality of shredded slips 11, as shown in FIG. 1;

(b) cutting another piece of glittery foil 2 into slips 21 with different geometric shapes 21a on one end;

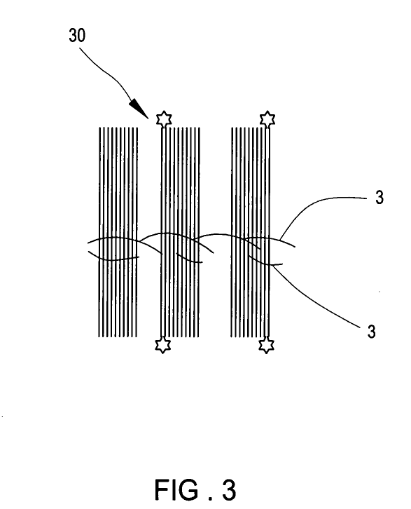

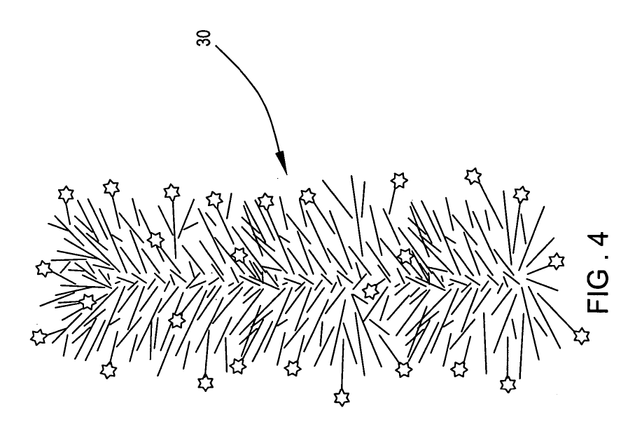

(c) coiling the shredded slips 11 and the slips 21 with different geometric shapes 21a on one end by at least two threads 3 so as to form a fluffy garland 30, as shown in FIG. 3 & FIG. 4;

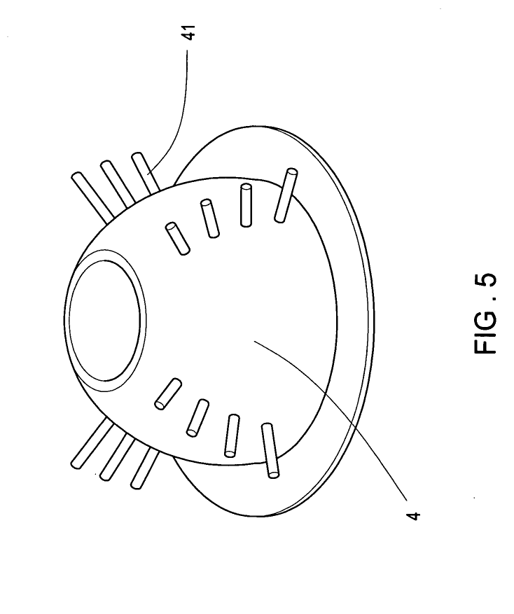

(d) disposing fixing pins 41 on a hemispheric base 4, as shown in FIG. 5;

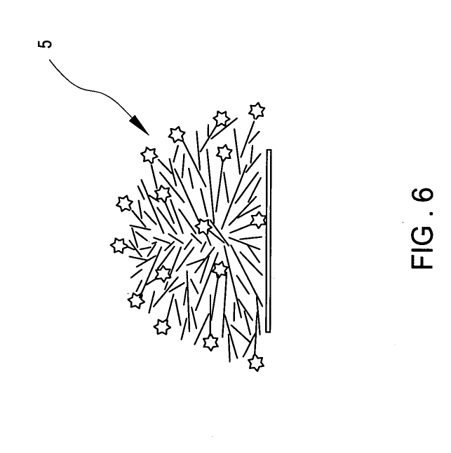

(e) winding the fluffy garland 30 on the hemispheric base 4 and fixing the fluffy garland 30 by the fixing pins 41 so as to form a three-dimensional, hemispheric color ball 5, as shown in FIG. 6.

In accordance with the manufacturing method mentioned above, the manual cutting of the shredded slips 11 and the slips 21 with different geometric shapes 21a on one end and the coiling of them with two threads 3 to form a fluffy garland 30, these two operations can be replaced by automatic machines so as to decrease the manufacturing cost.

Moreover, the hemispheric base 4 with fixing pins 41 is produced by the plastic injection molding. This also advances the producing efficiency and reduces the manufacturing cost.

Furthermore, the fluffy garland 30 is winded on the surface of the hemispheric base 4 and is fixed by fixing pins 41 so as to form a three-dimensional color ball in hemispheric shape, as shown in FIG. 6. The manufacturing speed is accelerated and the market viability is enhanced.

In addition, shredded slips 11 and the slips 21 with different geometric shapes 21a on one end can be made from glittery foils 1, 2 with different colors so as to increase the varieties of color balls. And the geometric shapes 21a of the slips 21 can be leaf-shaped or zoomorphic for better decorating effect.

It should be noted that the above description and accompanying drawings are only used to illustrate some embodiments of the present invention, not intended to limit the scope thereof. Any modification of the embodiments should fall within the scope of the present invention.

1. (a) cutting a piece of glittery foil into a plurality of shredded slips;
(b) cutting another piece of glittery foil into slips with different geometric shapes;
(c) coiling the shredded slips and the slips with different geometric shapes on one end by at least two threads and forming a fluffy garland;
(d) disposing fixing pins on a hemispheric base;
(e) winding the fluffy garland on the hemispheric base and fixing the fluffy garland by the fixing pins so as to form a three-dimensional, hemispheric color ball.
